(19) United States
(12) Patent Application Publication
(10) Pub. No.: US 2001/0054898 A1
(43) Pub. Date: Dec. 27, 2001

(54) MAGNETIC RESONANCE IMAGING COMPENSATED FOR VERY RAPID VARIATIONS IN STATIC MAGNETIC FIELD

(76) Inventors: ANDREW LI, SOUTH SAN FRANCISCO, CA (US); DAVID M GOLDHABER, SAN MATEO, CA (US); WEIGUO ZHANG, FOSTER CITY, CA (US); HECTOR AVRAM, SOUTH SAN FRANCISCO, CA (US); DAVID M KRAMER, CORTE MADERA, CA (US)

Correspondence Address: NIXON & VANDERHYE, 1100 NORTH GLEBE ROAD, 8TH FLOOR, ARLINGTON, VA, 222014714

(21) Appl. No.: 09/265,568

(22) Filed: Mar. 10, 1999

(51) Int. Cl. G01V 3/00

(52) U.S. Cl. 324/307; 324/309; 324/318

(57) ABSTRACT

A magnetic resonance imaging method and apparatus gathers NMR image data over a sequence of measurement cycles. First magnetic gradient pulses are superimposed on a nominally static magnetic field to selectively address NMR RF excitations for at least one predetermined volume and second magnetic gradient pulses are superimposed on the static magnetic field at other times in a measurement cycle. At least one further of the measurement cycles is performed during which at least one of the second gradient pulses is omitted so as to produce calibration data representative of the magnetic field then existing in the predetermined volume. The calibration data is used to produce MRI data compensated for phase angle errors which otherwise would be present due to undesirable changes with respect to time in the magnetic field actually present in said predetermined volume. The MRI data is compensated for phase angle errors by applying to the measured image data the inverse of the phase angles determined during the at least one further of the measurement cycles.

### BACKGROUND OF THE INVENTION

1. Field of the Invention

The present invention is generally related to magnetic resonance imaging utilizing nuclear magnetic resonance (NMR) phenomena. More particularly, the present invention is directed to MRI methods and apparatus that correct for very rapid main magnetic field variations.

2. Description of the Related Art

Magnetic Resonance Imaging (MRI) has become a widely accepted and commercially available technique for obtaining digitized visual images representing the internal structure of objects (such as the human body) having substantial populations of atomic nuclei that are susceptible to nuclear magnetic resonance (NMR) phenomena. In MRI, nuclei in a body to be imaged are polarized by imposing a strong main magnetic field B₀. Selected nuclei are excited by imposing a radio frequency (RF) signal at a particular NMR frequency. By spatially distributing the localized magnetic fields, and then suitably analyzing the resulting RF responses from the nuclei, a map or image of relative NMR responses as a function of the location of the nuclei can be determined. Following a Fourier analysis, data representing the NMR responses in space can be displayed on a CRT.

Only nuclei with odd number of protons and/or neutrons have a magnetic moment and are susceptible to NMR phenomena. The strong static magnetic field aligns the nuclei, generating a gross magnetization vector aligned in parallel to the main magnetic field at equilibrium. A second magnetic field, applied transverse to the first field as a single RF pulse, pumps energy into the nuclei, which causes the gross magnetization vector to flip by, for example, 90°. After this excitation, the nuclei precess and gradually relax back into alignment with the static field. As the nuclei precess and relax, they induce a weak but detectable electrical energy in the surrounding coils that is known as free induction decay (FID). These FID signals (and/or magnetic gradient-refocused field echoes thereof), collectively referred to herein as MR signals, are analyzed by a computer to produce images of the nuclei in space.

A magnetization vector can be decomposed into longitudinal and transverse components in reference to the main B₀ field. Conventionally, the longitudinal component is defined as parallel to the B₀ field and the transverse component is defined as perpendicular to B₀. Once the magnetic vectors are disturbed from their equilibrium, processes known as “relaxation” cause the longitudinal component to recover to an equilibrium magnitude, M₀, in alignment with the background B₀ field, and the transverse component to decay. These relaxation processes are termed the “spin-lattice relaxation” and the “spin-spin relaxation” and are characterized by exponentials whose time constants are T₁ and T₂, respectively. In addition to T₂ relaxation, inhomogeneities in the magnetic field B₀ cause the transverse component to further decay. An “apparent relaxation” time constant, T₂*, is therefore defined as characterizing transverse signal decay due to both spin-spin relaxation and the presence of B₀ field inhomogeneities.

The NMR frequency and the main B₀ field are related by the Larmor relationship. This relationship states that the angular frequency, ω₀, of the precession of the nuclei is the product of the magnetic field, B₀, and the so-called magnetogyric ratio, γ, a fundamental physical constant for each nuclear species:

ω₀=B₀γ(1−σ)

where σ is a shielding factor representing the chemical environment around the nuclei, commonly referred to as the “chemical shift.”

The RF spin-nutating pulse will, of course, tip more than one species of the target isotope in a particular area. After being tipped away from equilibrium, each species of nuclei will begin to precess at their own characteristic speed. The phase of the precessing nuclei species will gradually differ (de-phase) as a result of parameters such as the physical or chemical environment in which the nuclei are located. Nuclei in fat, for example, precess at a different rate than do nuclei in water due to the effects of chemical shift. In addition, inhomogeneities in the magnetic field also contribute to de-phasing of the nutated precessing nuclei.

Typically, there are small spurious variations in the magnetic fields (i.e., the static magnetic field and the magnetic gradient fields) during NMR measurement processes. For example, the rapid imposition of a sequence of magnetic gradient fields produces eddy currents in nearby conductive members. The magnetic field produced by these eddy currents is directed so as to oppose the magnetic field that induced the eddy currents. Since these eddy currents do not instantaneously vanish when the magnetic gradient pulses are switched off, remnant magnetic fields may still be present, for example, when the NMR RF response signal occurs.

Various systems provide compensation for these variations in the magnetic fields during NMR data measurements. For example, U.S. Pat. No. 4,885,542 to Yao et al. compensates for field/phase errors caused by remnant eddy currents using calibration “template” measurements before, during and after the imaging acquisition. Such extra calibration measurements are very useful in compensating for a relatively slow, essentially linear variation of a nominally static B₀ magnetic field. Other techniques have been provided to compensate for more rapidly varying spurious magnetic fields. For example, U.S. Pat. No. 4,970,457 to Kaufman et al. describes a technique for compensating for relatively rapid variations in static magnetic fields occurring with periods as short as (or shorter than) a single MRI sequence.

However, it has been found that there are even more rapidly varying variations in B₀ which must be compensated. These variations include variations caused by a rapid, possibly oscillatory, field fluctuation due to the imaging gradients themselves. Thus, while, for example, the technique of Kaufman et al. is very useful for compensating for variations which are “rapid” with respect to the time of the imaging scan—typically several minutes—new techniques are required to compensate for magnetic field variations which are rapid with respect to the fraction of a second used to acquire a single line of NMR data.

### BRIEF SUMMARY OF THE INVENTION

The present invention provides for the compensation of magnetic field variations which are rapid with respect to the fraction of a second used to acquire a single line of NMR data.

In accordance with one aspect of the present invention, compensation is provided based on measurements of the rapid field vibrations. In particular, a magnetic resonance imaging method and apparatus gathers MRI data over a sequence of measurement cycles. Magnetic gradient pulses are superimposed on a nominally static magnetic field during a sequence of measurement cycles to generate MRI data for a predetermined volume. Variations in the static magnetic field with respect to time generated by the magnetic gradient pulses are measured and the measured variations are used to produce MRI data compensated for errors which otherwise would be present in the magnetic field actually present in said predetermined volume due to the magnetic gradient pulses themselves.

In accordance with another aspect of the invention, compensation is provided during sequence development. In particular, a magnetic resonance imaging method and apparatus gathers MRI data over a sequence of measurement cycles. Magnetic gradient pulses are superimposed on a nominally static magnetic field during a sequence of measurement cycles to generate MRI data for a predetermined volume. At least one of the shape and the position of the magnetic gradient pulses is used to compensate for variations in the static magnetic field with respect to time caused by the magnetic gradient pulses themselves.

In accordance with yet another aspect of the present invention, compensation is provided by applying corrections after acquisition of the image data. For example, a magnetic resonance imaging method and apparatus gathers MRI image data over a sequence of measurement cycles. First magnetic gradient pulses are superimposed on a nominally static magnetic field to selectively address NMR RF excitations for at least one predetermined volume and second magnetic gradient pulses are superimposed on the static magnetic field at other times in a measurement cycle. At least one further of the measurement cycles is performed during which at least one of the second gradient pulses is omitted so as to produce calibration data representative of the magnetic field then existing in the predetermined volume. The calibration data is used to produce MRI data compensated for phase angle errors which otherwise would be present due to undesirable changes with respect to time in the magnetic field actually present in said predetermined volume. The MRI data is compensated for phase angle errors by applying to the measured image data the inverse of the phase angles determined during the at least one further of the measurement cycles.

In another magnetic resonance imaging method and apparatus, MRI data is gathered from an imaged volume over a sequence of measurement cycles. At least one pair of further calibration measurement cycles is performed, wherein the polarity of all gradient pulses utilized in one cycle is reversed for another cycle and the respectively corresponding phases of measured NMR RF responses obtained in the pair of cycles is subtracted to provide calibration data substantially without chemical shift artifact and in the absence of applied magnetic gradients. The calibration data is used to produce MRI data compensated for errors which otherwise would be present due to undesirable changes with respect to time in the magnetic field actually present in the imaged volume.

These, as well as other features and advantages of this invention, will be more completely understood and appreciated by careful study of the following more detailed description of a presently preferred exemplary embodiment of the invention taken in conjunction with the accompanying drawings.

### BRIEF DESCRIPTION OF THE DRAWINGS

FIG. 1 shows the components of an NMR imaging system.

FIG. 2A illustrates a spin echo sequence and FIG. 2B illustrates a field echo sequence.

FIG. 3 shows the positioning of a square phantom in the center of an MRI magnet in the readout direction.

FIG. 4 shows the results of taking out the magnitude and performing an FFT in the readout direction on data with the signal from the phantom.

FIG. 5 shows the impulse response of the field vibration.

FIG. 6A shows a typical gradient pulse.

FIG. 6B shows a field echo sequence modified in accordance with the present invention.

FIG. 7 shows data generated during a field echo sequence using a conventional spoiler pulse.

FIG. 8 shows data generated during a field echo sequence modified in accordance with the present invention.

FIG. 9 shows the distance T between a first PE encoding pulse and a second PE encoding pulse.

FIG. 10 provides a schematic pictorial depiction of an embodiment of the present invention in which a template obtained at the end of a given scan (“the last template”) is used.

FIGS. 11A and 11B illustrate sequences used in the two template compensation method of the present invention.

FIGS. 12A and 12B illustrate test results before applying the image corrections of the present invention and after applying the image corrections of the present invention, respectively FIG. 13 illustrates a data/template acquisition diagram without template slice.

FIG. 14 illustrates a data/template acquisition with template slice.

FIG. 15 illustrates a data/template acquisition diagram with template lines for field stability correction.

### DETAILED DESCRIPTION

As is well-known, nuclei precess at a particular frequency with a particular phase. By applying gradient fields to the nuclei in different orthogonal directions, the frequency and phase of the precessions can be used to spatially encode the nuclei. In one orthogonal direction, a “slice” of nuclei is excited. Within that slice, MR signals are extracted from the remaining two dimensions of the slice, using the frequency of precession of the selected nuclei to spatially encode the nuclei in one direction and using the phase of precession of the selected nuclei to spatially encode the nuclei in the second (or other) direction(s). By analyzing the complex frequency and phase of the resultant MR signal, information about the nuclei density in the selected slice can be determined.

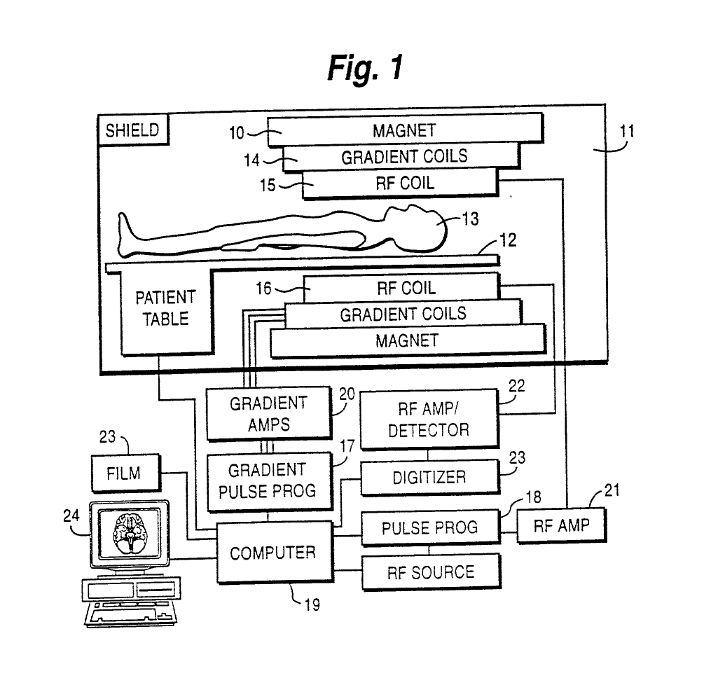

The procedures of the present invention can be provided by suitable alteration of the control programs of existing MRI apparatus. FIG. 1 shows one illustrative, but non-limiting, example of an MRI system which may comprise a large polarizing magnet structure 10 which generates a substantially uniform homogenous polarizing magnetic field B₀ within a patient imaging volume 11. A suitable carriage 12 inserts the desired portion of patient 13 anatomy within the image volume 11. Magnetic gradients are selectively created by electromagnetic gradient coils 14. RF nuclei nutation pulses are transmitted into the patient tissue within the image volume by RF coil 15. The RF responses constituting the MR signal are received from the patient tissue via suitable RF detection coil structures 16.

To acquire MRI data, the MRI system generates magnetic gradient and RF nutation pulses via MRI pulse sequence controllers 17 and 18 under the control of programmable computer/processor 19. In addition, processor 19 controls gradient pulse amplifier 20 and RF source and amplifier circuits 21 and 22. The NR signal (RF detector) circuits 22 are suitably interfaced with MR signal RF coils 16 located within the shielded MRI system gantry. The received MR responses are digitized by digitizer 23 and passed to processor 19 which typically includes an array processor for image processing and suitable computer program storage media (not shown) wherein programs are stored and selectively utilized so as to control the acquisition and processing of NR signal data and to produce image displays on CRT of control terminal 24. The MRI system is provided with a control terminal 24 which may include suitable keyboard switches and the like for exerting operator control over the imaging sequence controllers 17 and 18. Images may also be recorded directly on film or on other suitable media by printing device 23.

In conjunction with system computer/processor 19, an operator is typically presented with a menu of choices for MRI sequences and data processing techniques. At least some of these sequences and data processing techniques may include programs which incorporate the inventive techniques for compensating for variations to the static magnetic field which are described below. The generation of suitable detailed computer program for effecting the inventive techniques is believed to be well within the ability of those skilled in the art in view of the detailed disclosure herein.

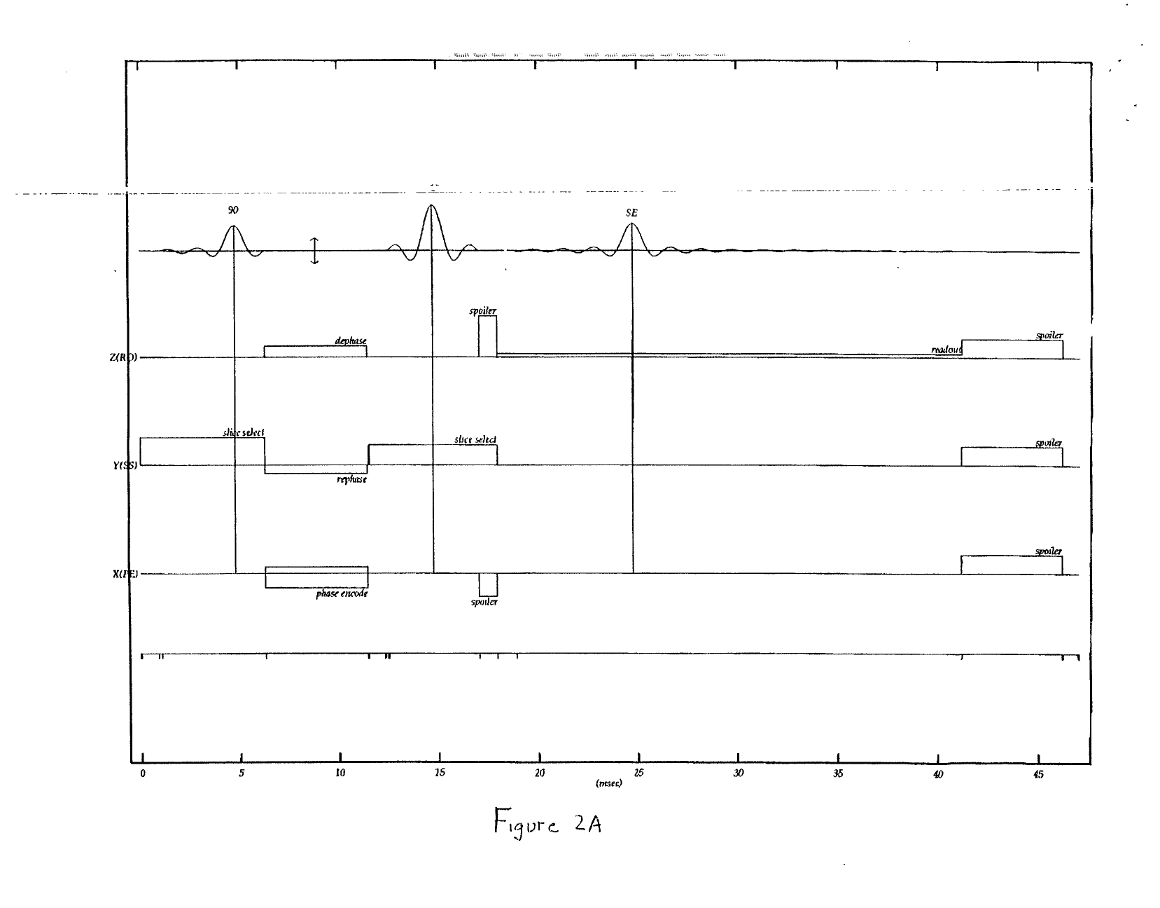

The operation whereby the various coils produce RF excitation pulses and gradient fields to result in and acquire an MR signal is called an MRI acquisition sequence. By way of example, but not limitation, the invention is described below in terms of two different typical sequences used in MRI having artifacts which are correctable using the present invention. The first is a spin echo sequence and the second is a field echo sequence. A spin echo sequence is illustrated in FIG. 2A and a field echo sequence is illustrated in FIG. 2B. Since these sequences are well-known, a brief description will be provided only with respect to the field-echo sequence shown in FIG. 2B.

In a field-echo sequence, the MR signals appear as gradient-refocused field echoes. First, a gradient field, G_{slice}, is superimposed along the main field to sensitize a slab of nuclei in the body to be imaged to a particular RF resonance frequency. An RF excitation field or nutation pulse is then applied at the particular frequency to tip the magnetization away from equilibrium. Thereafter, pulsed magnetic gradient fields of changing magnitudes, Gₚₑ and G_{slice}, are used to phase encode the nuclei by inducing a temporary frequency difference, and hence phase difference, between nuclei in different locations along a specific direction within the slab. At the same time, another pulsed magnetic gradient field, Gᵣₒ, is applied perpendicular to the direction of Gₚₑ, in a readout (ro) direction that first de-phases and then rephases the precessing nuclei which results in a field-echo MR signal. The time from the center of nutating pulse to the center of the field-echo MR signal is the echo time, TE, and the entire pulse sequence duration is designated as TR. Thus, the applied gradient field, Gᵣₒ, frequency encodes the selected slab of nuclei in the readout direction. The resultant MR signal (also called “raw data” or “k-space data”) is then read and analyzed using Fourier analysis. A frequency domain plot of that analysis is then scaled to render information about the nuclei population in Fourier space (also referred to as the image domain), which corresponds to an X-Y-Z position.

The sudden gradient changes generate eddy currents on the inner walls of the cryostats of the magnet used to produce the static magnetic field. These eddy currents in turn generate mechanical vibrations, a vibration in the central field and finally a phase vibration in the raw data along the read out direction. The phase vibration in the raw data is also caused by direct mechanical coupling of the gradient coils to the structure of the magnet. The present invention is directed to the compensation of variations in the central field B₀ which are very rapid (e.g., fast compared to with the fraction of a second used to acquire a single line of NMR data) and which are caused by the imaging gradients themselves.

In terms of the compensation of central field vibration, the spin echo and field echo sequences have three types of gradient pulses: (1) PE and SE phase encoding pulses; (2) readout window pulses; and (3) other gradient pulses such as the readout dephasing pulses; slice selection and rephasing pulses; spoiler pulses; and flow compensation pulses.

PE and SE phase encoding pulses are different from other gradient pulses in that they are changing during the acquisition. The readout window pulse is different from other gradient pulses in that it is on during the signal acquisition. Accordingly, these pulses must sometimes be treated differently. The various methods described below are generally suitable for all category (3) gradient pulses, but may not be suitable for the category (1) and category (2) gradient pulses. This will be noted as appropriate.

Testing by the Applicants has shown that the central field vibration is uniform and can be described by:

P(t)=A0 cos (2πw0t+F0)e^{-t/s0}+A1 cos (2πw1t+F1)e^{-t/s1}+A2 cos (2πw2t+F2)e^{-t/s2}+, (1)

where w0, w1, w2, etc. represent the frequency components and s0, s1, s2, etc. represent time constants.

The following simplified description of the central field vibration may be utilized for some sequences:

P(t)=A0 cos (2πw0t+F0)e^{-t/s0} (1′)

When the time constant is long enough in comparison to the readout window, the following even simpler description of the central field vibration may be utilized:

P(t)=A0 cos (2πw0t+F0). (1″)

A method suitable for quantifying the artifacts generated by the central field vibration for sequences without template lines will now be described. More particularly, this method measures the field vibration impulse response for any sequence (without modification to the sequence) using a cubic phantom. The method is based on an assumption that the contribution of the PE and SE phase encoding pulses can be ignored.

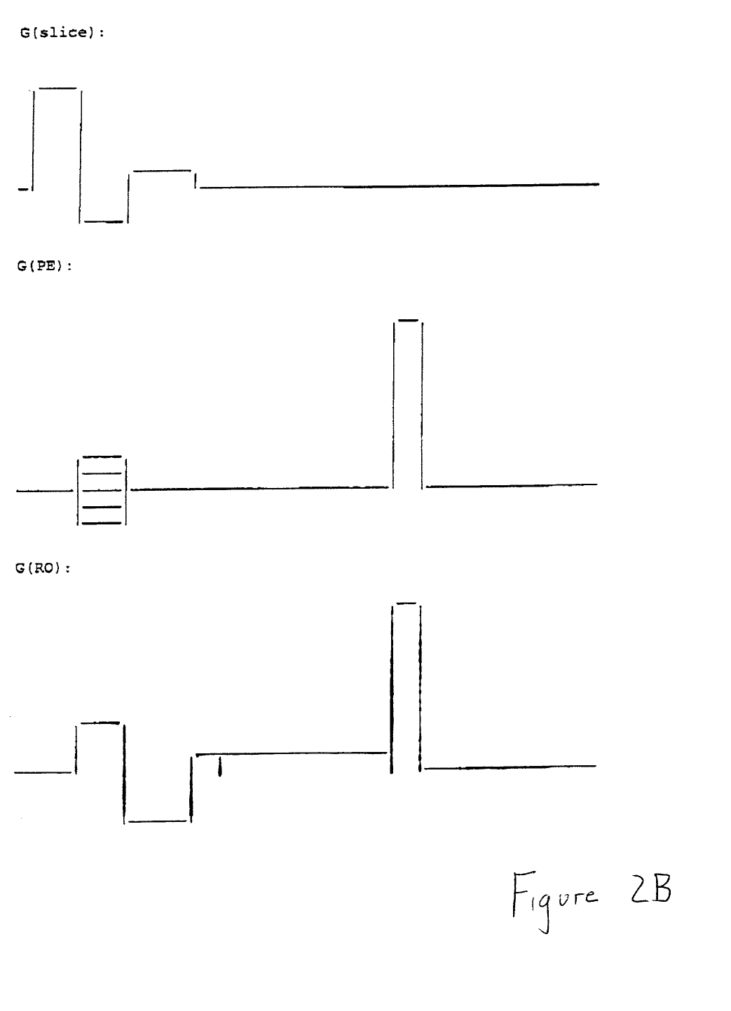

Step 1-1—A cubic phantom is positioned in the center of the magnet in the readout direction as shown in FIG. 3. The accuracy with which the cubic phantom is placed is not critical.

Step 1-2—An FFT is taken in the phase coding direction. Each line of the data with the signal from the phantom can be mathematically described as:

U(t)=M(t)e^{i(F(t)+P(t))} (2)

where P(t) is the phase vibration generated by those pulses in the form of equation (1); M(t) is the magnitude of the signal without field vibration; and F(t) is the phase of the signal without field vibration.

Step 1-3—The magnitude is taken out and an FFT is taken in the readout direction. Mathematically:

V(t)=U(t)/MAG(U(t))=e^{i(F(t)+P(t))}; (3)

and

v(x)=FFT(V(t)). (4)

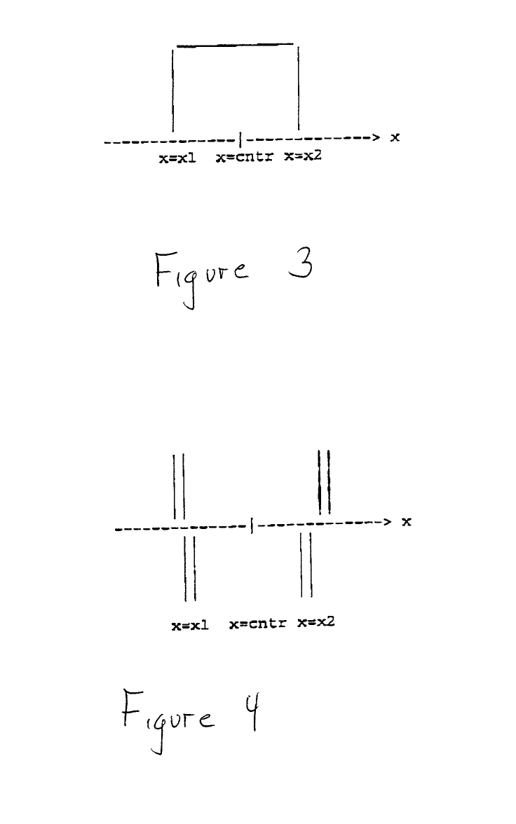

See FIG. 4.

Step 1-4—Let v1 be the left side of v(x) and v2 be the right side of v(x). Then:

v1(x)=v(x) if (x<center); v1(x)=0 otherwise; (5)

and

v2(x)=v(x) if (x>center); v2(x)=0 otherwise. (6)

v1(x)=v0(x−x1) convolution with p(x); (7)

and

v2(x)=v0(x32−x) convolution with p(x). (8)

where v0 is a pulse, the exact shape of which depends on the resolution of the readout window (and is not critical) and p(x) is the FFT of e^{iP(t)}. Equations (7) and (8) follow with a high degree of accuracy from equations (5) and (6). The magnitude of U(t) is a sine function and is thus highly peaked in the center. By dividing U(t) by this magnitude and taking an FFT, v(x) is a high-passed image of the cubic phantom. The DC and lower frequency components are severely depressed. To a high degree of approximation, all that remain are contributions from the left and right edges of the phantom. Furthermore, since the left and right edges of the phantom are mirror images of each other, the contributions from the two edges in v(x) are mirror images; if the contribution from the left side is a function v0(x−x1), then the contribution from the right side is the same function reflected and with a different offset, v0(x2−x). The actual shape of the function v0 is not important. Only the mirror image property is relied upon, so that the FFTs of v1 and v2 are complex conjugates of each other, except for a linear phase ramp, which can be absorbed into L1 and/or L2 in equations (9) and (10) below. Of course, dividing U(t) by its magnitude is but one possible application. U(t) can equally well be divided by any function that performs a high-pass operation which suppresses nearly completely the DC and low frequency components.

Step 1-5—An inverse FFT is taken on v1 and v2 separately. The mathematical representation is as follows:

V1(t)=M0(t)e^{i(F0(t)+P(t)+L1 t+B1+N1(t))}; (9)

and

V2(t)=M0(t)e^{i(-F0(t)+P(t)+L2t+B2+N2(t))}, (10)

where M0(t)e^{iF0(t)} is equal to the inverse FFT of v0.

Step 1-6—W(t) is calculated as follows:

W(t)=(V1(t)V2(t))/MAG(V1(t))/MAG(V2(t))=e^{i(2P(t)+Lt+B+N(t))}. (11)

In equations (9), (10) and (11), the “L”'s are the slopes of phase ramps linear in t; the “B”'s are constant phase offsets; and the “N”'s are phase noise. Accordingly, L=L1+L2; B=B1+B2; and N=N1+N2.

Step 1-7—The zero and first order phase shift are taken out by p-domain centering and the scale constant 2 in the p-domain is taken out from the non-zero frequency component to yield the impulse response of the field vibration. Mathematically, the impulse response of the field vibration is given by:

W′(t)=e^{i(P(t)+N(t))}. (12)

Step 1-8—A simple threshold based on background noise is used to determine which lines of the data have signal from the phantom. The readout lines with signal are averaged to reduce noise.

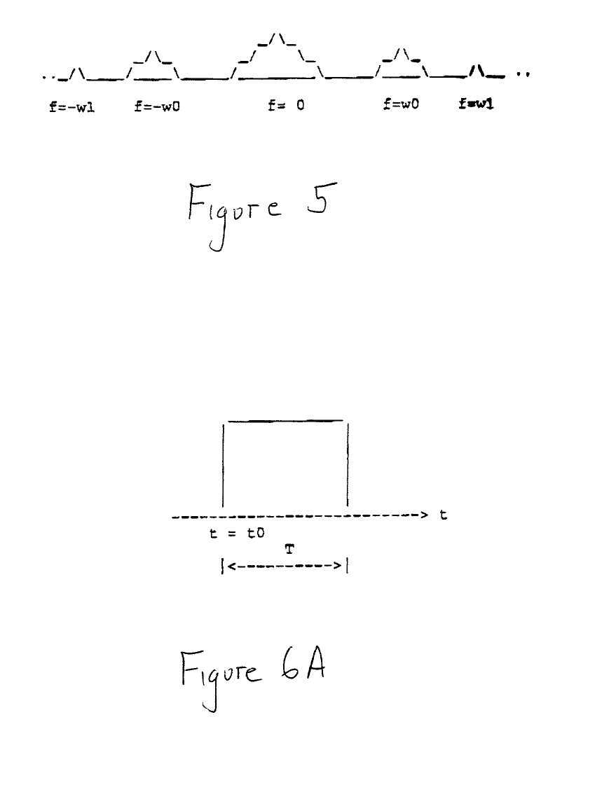

Step 1-9—With reference to FIG. 5, an FFT on W′(t) with zero-padding gives the impulse response of the field vibration. In this way, the w0, w1, w2, . . . in equation (1) are measured.

Applicants have drawn several important conclusions from testing.

First, the vibration is substantially uniform around the center of the magnet so that equation (1) is valid.

Second, for some sequences, there is only one major dominant frequency component. In these cases, equation (1′) can be used. In addition, if the time constant s0 is long enough, equation (1′) can be used for the sequence.

In other sequences, the situation is more complicated. For example, some spin echo sequences have at least two large frequency components. This in fact suggests that this measurement method is more accurate than other methods that assume a single or fixed number of frequency components. In this case, equation (1) provides a better description of the central field vibration.

Due to the relatively long time constant of the mechanical vibration, the central field vibration discussed herein has a different nature than the central field vibration generated by eddy current alone. If in a TR cycle (about 500 ms), one or more fewer slices than usual are acquired, the artifacts in the data are either reduced or eliminated. This suggests that the artifacts in the data are accumulated effects, not only from those gradient pulses immediately in front of the readout window within the slice cycle, but also from those gradient pulses placed in other slice cycles.

The calculated impulse response can be transformed back and taken out to check the accuracy of the measurement. The phase pattern can be saved for later use with real data acquired with the same sequence and the same acquisition parameters. The same concept should be applicable to real data images if some figures in the data (e.g., the edge of the head) can be isolated. Thus, this method provides a direct field vibration correction method. All that is believed to be required is that the image contain two mirror edges, as, for example, opposite edges of an axial or coronal head image. These two edges can be used to find v1(x) and v2(x) just as the two edges of the cubic phantom are used.

In accordance with another aspect of this invention, a method is provided which is usable to reduce field vibrations and the phase distortions in the image data. The method herein was developed with the assumption that the field vibration can be characterized by equation (1′), where w0 is the frequency and s0 is the time constant. Of course, the principles set forth herein are not limited to a particular characterization of the nature of the field vibration.

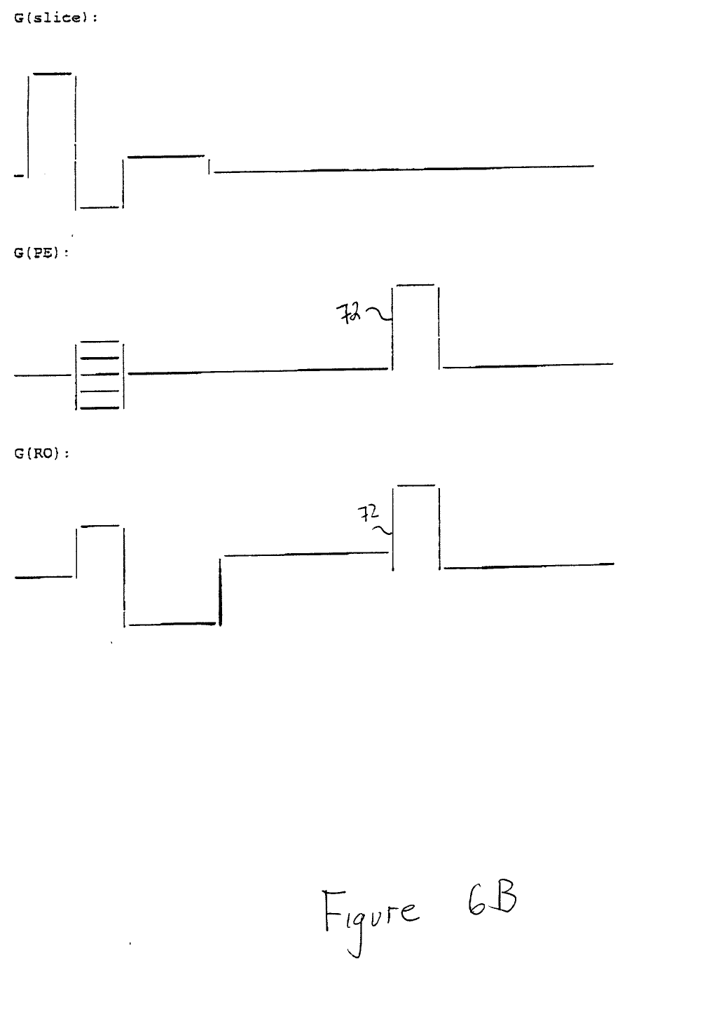

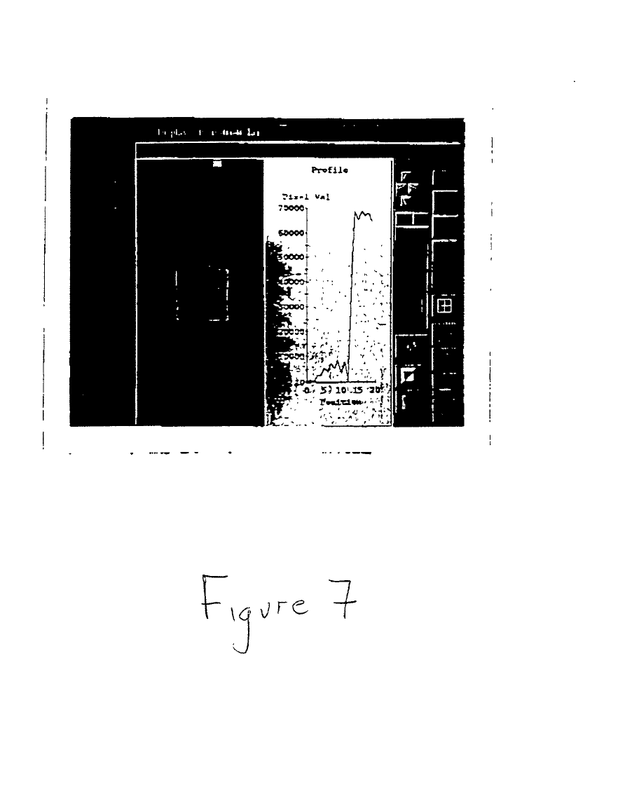

A typical gradient pulse used in sequences is shown in FIG. 6A. If the phase vibration generated by the front edge of this pulse is expressed mathematically as:

A0 cos (2πw0(t−t0))e^{-(t-t0)/s0}, (16)

then the phase vibration generated by the trailing edge of the pulse should be

−A0 cos (2πw0(t−t0−T))e^{-(t-t0-T)/s0}. (17)

When t0<<s0, and if T is about equal to t0 (or 2*t0, . . .), the two vibrations are out of phase and will approximately cancel each other, while if T is about t0/2 (or t0/2+t0, . . . ), the two vibrations are in phase and will add together.

Using the spoiler pulse in the field echo sequence as an example, it can be seen that by changing the length of the pulse from 3 ms to 6 ms, the strength of the vibration will be reduced. Mathematically,

$$ratio = \frac{Exp ( t0 / s0 ) - 1}{Exp ( t0 / 2 / s0 ) + 1} = \frac{0.0689}{2.0339} = 3.39 \%$$

Another factor of 2 can be gained by reducing the strength of the gradient by one-half. The penalty for this reduction in strength of vibration is that the length of the sequence increases, in this case, by 3 ms per slice.

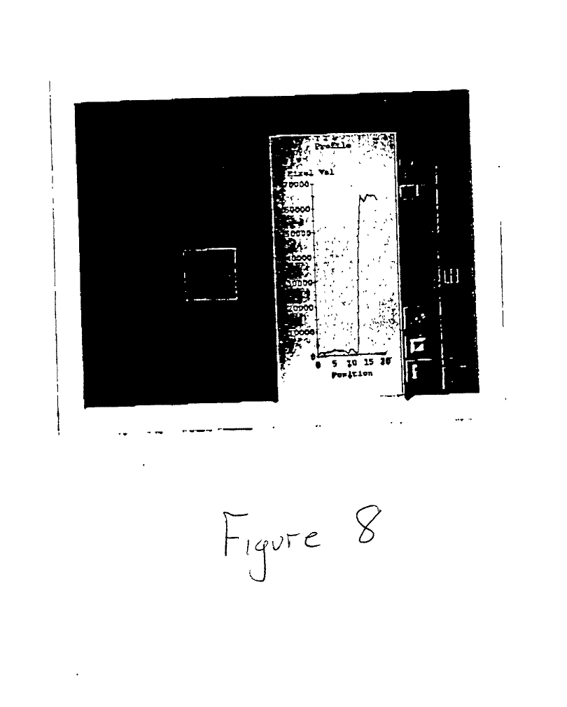

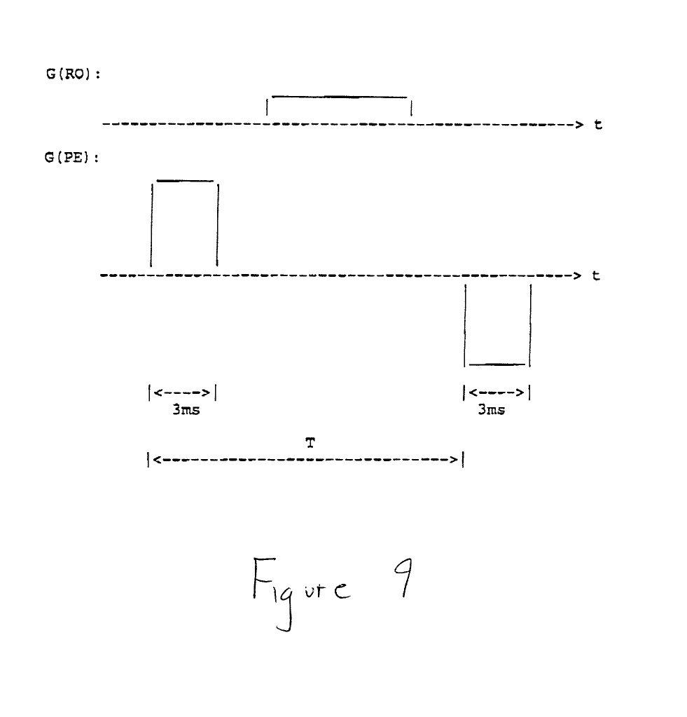

This technique was tested by applying it to the field echo sequence. FIG. 6B shows the modified sequence in which the pulse length of the spoiler pulses 72 have been increased from 3 ms to 6 ms and the magnitude of these spoiler pulses have been halved as compared with the sequence of FIG. 2B. FIG. 7 shows data acquired with the original sequence of FIG. 2B and FIG. 8 shows data acquired with the modified sequence of FIG. 6B. A comparison of FIGS. 7 and 8 shows that the artifacts in FIG. 7 are reduced in FIG. 8.

The present invention also contemplates field vibration compensation among gradient pulses in each direction. Due to the time constant s0 and other factors, no vibration can be completely canceled by a gradient pulse itself. In addition, some gradient edges such as the front edge of the readout window pulse cannot be canceled. The shape and position of one of the existing pulses of a sequence may be purposely changed to compensate other pulses. An extra gradient pulse (or the existing spoiler pulse) may be used to compensate other pulses. In some instances, one extra pulse for each gradient pulse may be utilized. These pulses are positioned just before the 90 degree RF pulse and have lengths and positions carefully designed to correspond to the magnitude of the residual vibration, but with opposite sign. A gradient pulse might not induce much vibration on its own; the continuation builds up a steady state vibration. Accordingly, the spoiler pulse may be adjusted on all odd and even slices so that this “sewing effect” can be reduced.

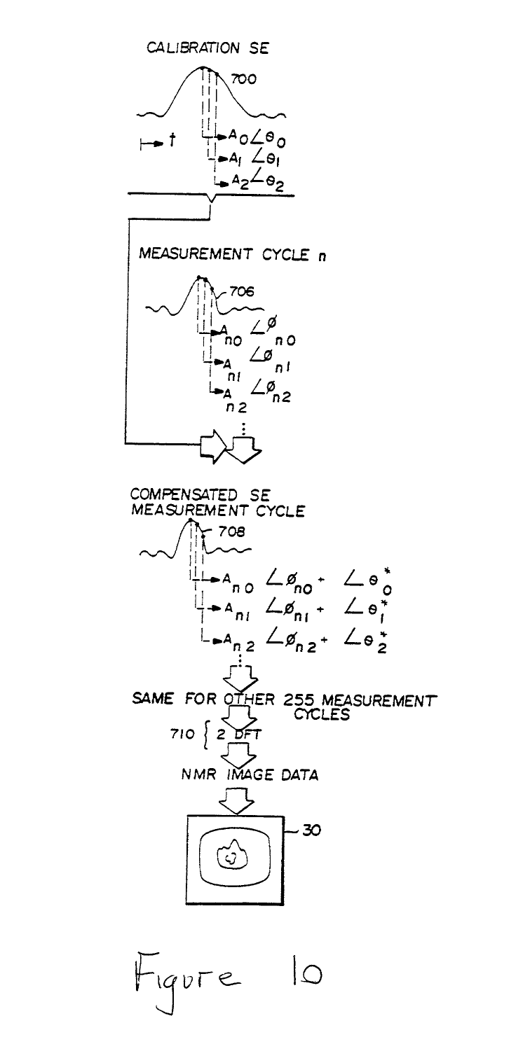

Testing has shown that in one fast spin echo sequence, the vibration and artifacts can be varied by changing the time distance T (see FIG. 9) between the first PE encoding pulse and the second PE encoding pulse.

The present invention further contemplates that field vibration compensation may be provided among gradient pulses in all gradient directions. For example, the two or three spoiler pulses might be shaped and positioned carefully so that vibrations generated by those pulses are out of phase so that total vibration is reduced.

Thus, the present invention contemplates providing an additional design factor during the development of sequences. Of course, during the sequence design, the compensation for central field vibration must be weighted against other factors. In some cases, these other factors might be so dominant that nothing can be done to compensate the field vibration by sequence designing. In these cases, the vibration may be corrected by software, for example. One such software correction is described in detail below. However, sequence designing is simple and does not depend on the signal to noise ratio in the image data. Thus, utilizing sequence design, where possible, to compensate for rapid central field vibrations is very advantageous.

In accordance with another aspect of the invention, calibration templates are generated. These calibration templates are like imaging phase encoded acquisitions except that the phase encoding gradient is omitted as well as any frequency encoding gradient during readout of the NMR signal. This calibration data may be used in several ways. As will now be described, in one, the vector of the phase angles of each of the template data points is recorded and the precise inverse of the template phase angles is applied to each acquired imaging data point. This is effective for compensating for the rapid, possibly oscillatory, field fluctuation caused by the imaging gradients.

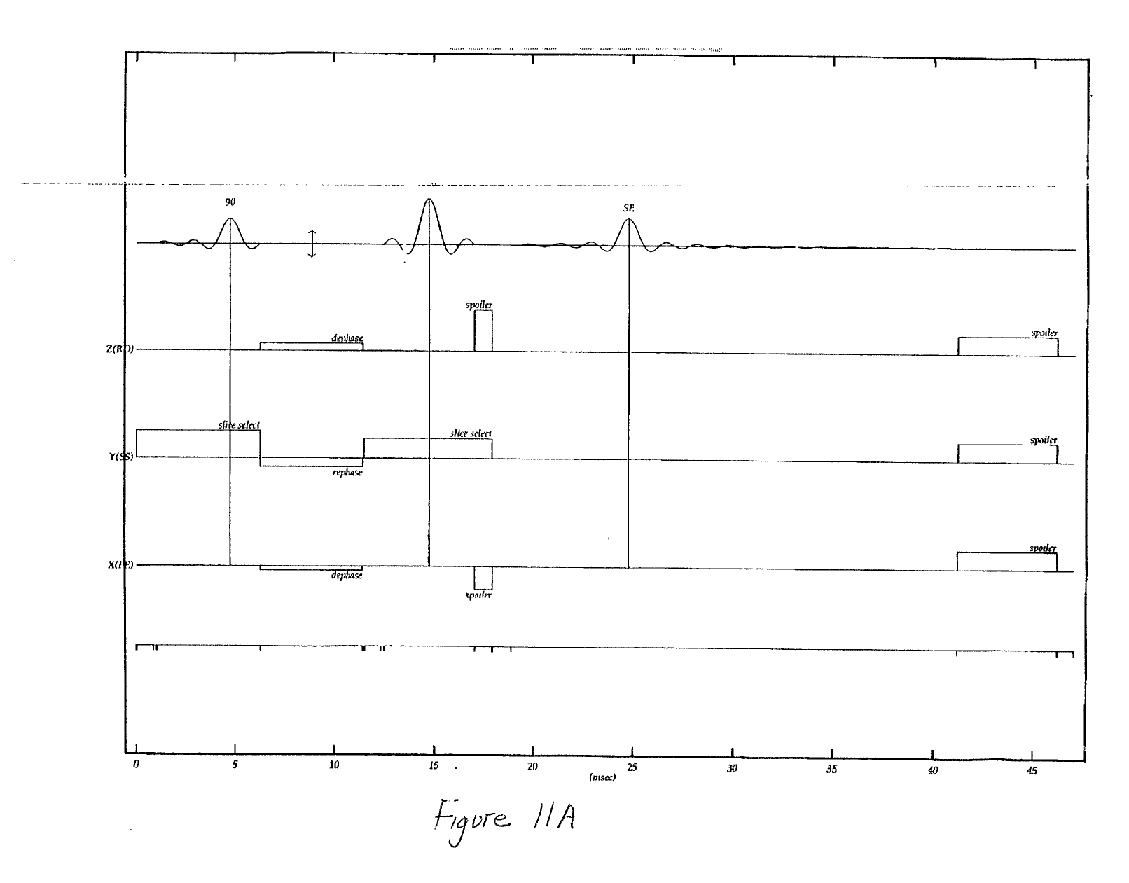

In practice, the generation of calibration data may be accomplished in a number of ways. For example, special calibration cycles in which at least some and preferably all of the magnetic gradient pulses (except for the slice selective gradient pulses) are omitted may be interspersed within the normal scan sequence or may be tacked on to the beginning and/or end of such a sequence. FIG. 10 shows an example of such a special calibration cycle.

FIG. 10 provides a schematic pictorial depiction of an exemplary embodiment of the present invention in which a template obtained at the end of a given scan (“the last template”) is used. The time domain spin echo for the last template is depicted at 700. As will be appreciated, the envelope 700 is actually represented by a succession of stored digital data representing the amplitude A and relative phase θ of each of successive sampling points measured by suitable analog-to-digital converter apparatus during the actual occurrence of the time domain spin echo of the last template.

The original time domain spin echo data 706 is also shown in FIG. 10 for a typical measurement cycle n of the N measurement cycles of a complete single scan sequence. This original time domain data may be compensated to provide compensated data 708 by performing phase corrections based on the last template data before performing the usual multi-dimensional Fourier Transformation at 710 to produce NMR image data and a display at 30.

Thus, the present invention provides for a point-by-point phase angle compensation. The uncompensated measured data is a vector of complex data points Aₙₘe^{iφnm}, where n is the phase encoding number and m is the frequency encoding or time point number. The calibration template is similarly a vector of complex data points Aₘe^{iφm}. In accordance with the method of the present invention, the following correction is applied to measured imaging data before it is Fourier transformed:

Aₙₘe^{iφnm}→Aₙₘe^{i (φnm-θ).}

These phase angle corrections are precisely the inverse of the template phase angles θₘ. Such corrections are different, for example, from the interpolated phase angles θ(n/N) applied by Yao et al. The interpolated phase angles of Yao et al. are the proper corrections when the source of the phase angle errors is a slowly varying perturbation unrelated to the imaging gradient, or at least is related only to the build-up of a slowly varying eddy current with a very long time constant. The phase angle corrections of the present invention are appropriate when the main source of the phase errors is a rapid, possibly oscillatory, field fluctuation caused by the imaging gradients. Such errors can be caused by electromechanical coupling (“microphonics”) between various elements of the gradient and magnet assemblies. In this case, the phase angle errors are essentially identical in the template and in each of the imaging phase encoded projections. Interpolation in this case is unnecessary and counterproductive.

In order to provide more tolerance to field inhomogeneity and chemical shift, two sets of calibration data (i.e., two template lines) may be utilized to effect compensation. In accordance with the present invention, the slice-select gradient and all other gradients imposed (spoiler, flow compensation, etc.) during the first of a pair of templates have inverted signs in the second template. This ensures that the phase angle errors induced by all gradients are properly compensated. The phase angles of the two templates are averaged point-by-point, thus removing any contribution from magnet and chemical inhomogeneity. These averaged phase angles are then applied as a correction to the measured imaging data phase angles, prior to the Fourier transform, as described above for the single-template case.

The two template compensation method will now be described in detail. This method corrects the phase distortion generated by those gradient pulses other than PE and SE phase encoding pulses. The steps of this method are as follows:

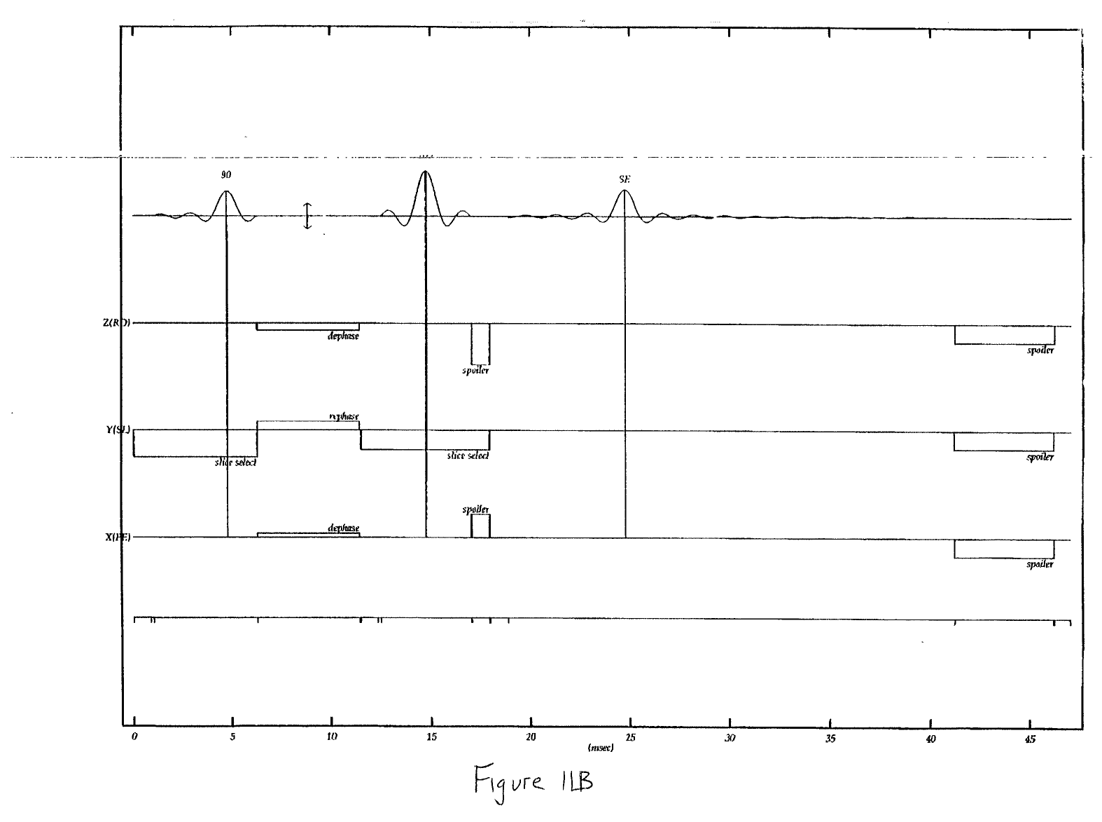

Step 2-1—A template line is acquired with the PE/SE table pulses off, and the RO readout window pulse off as shown in FIG. 11A. The signal can be described as:

S1(t)=S0(t)e^{iP0(t)}, (18)

where PO(t) is the phase vibration generated by pulses having the form of equation (1) above, and SO(t) is the signal without field vibration:

S0(t)=M(t)e^{iF(t)}, (19)

where M(t) is the magnitude of S0(t) and F(t) is the phase of S0(t).

Step 2-2—A second template line is acquired with the PE/SE table pulses off, and RO readout window pulse off as in the case of the first template. However, the direction of all other pulses is reversed as shown in FIG. 11B. For spoiler pulses, this change is simple. For the slice selection pulse, in addition to the direction change, the RF frequency may also need to be adjusted. The signal of the second template may be mathematically described as:

S2(t)=S0(t)e^{i(-P0(t)+L(t)+E(t))} (20)

where L(t) (=L0+L1 t) is a constant and a first order phase shift created by RF frequency shift and E(t) is other unexpected errors due to the imperfection of the magnet and noise.

Step 2-3—The following calculation is then performed:

S3(t)=S0(t) CONJ(S1(t))/MAG(S0(t))/MAG(S1(t))=e^{i(2P0(t)+L(t)+E(t))}. (21)

Step 2-4—P-domain centering is performed to take out the zero and first order term L(t).

Step 2-5—The constant 2 is taken out from the p-domain (i.e., the frequency spectrum of S4(t)).

Steps 4 and 5 may be performed in the following manner:

Taking the FFT with a zoom factor (that is zero-padding) (e.g., zoom factor of 8);

Centering the peak (first order);

Taking out the phase of the peak (zero order);

Scaling by 2 for all those frequency components larger than (zoom factor/2);

Optionally applying a low pass filter (or zeroing out higher frequency components); and

Taking the inverse FFT.

These steps result in:

S4(t)=e^{i(P0(t)+E(t))}, (22),

which is the impulse response of the field vibration generated by the gradient pulses.

Step 2-6—The phase vibration S4(t) is taken out of the data.

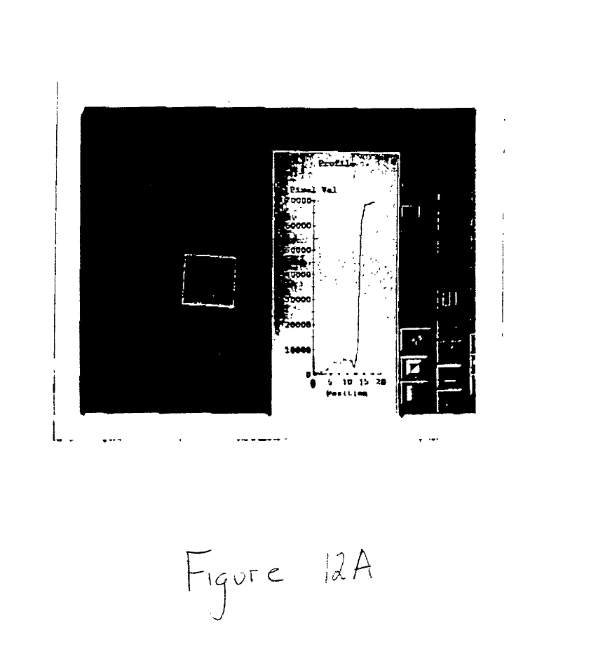

FIGS. 12A and 12B illustrate test results for a spin echo sequence before applying the corrections of the present invention and after applying the corrections of the present invention, respectively. It can be seen that the corrections of the present invention reduce the artifacts present in the signal shown in FIG. 12A.

The phase angles compensated by the present invention are from microphonic modes having decay times that are on the order of the time between phase encoded measurements. Thus, a more accurate measurement is made of the phase angle errors if the gradients are cycled a few times—so as to achieve a steady state—before recording the template data. This applies equally to each of a pair of templates having gradients of opposite sign. In addition, to improve signal-to-noise ratio, to reduce the field change introduced by other environmental factors, and to have the magnet properly initialized, a plurality of templates may be averaged. For example, Applicants have found that at least four templates should be averaged to achieve these benefits.

If data is acquired without an extra template slice used for field stability correction nor other spoiler pulses placed at the end of TR cycle, the phase distortion in each data slice should be the same. In this case, the two template lines with the strongest signals can be used for correction on all slices or the averaged phase calculated from the template lines from all slices can be used to reduce the noise errors. FIG. 13 illustrates a data/template acquisition diagram without template slice. In FIG. 13, M is the number of data slices, N is the number of readout lines and K is the number of field vibration template lines.

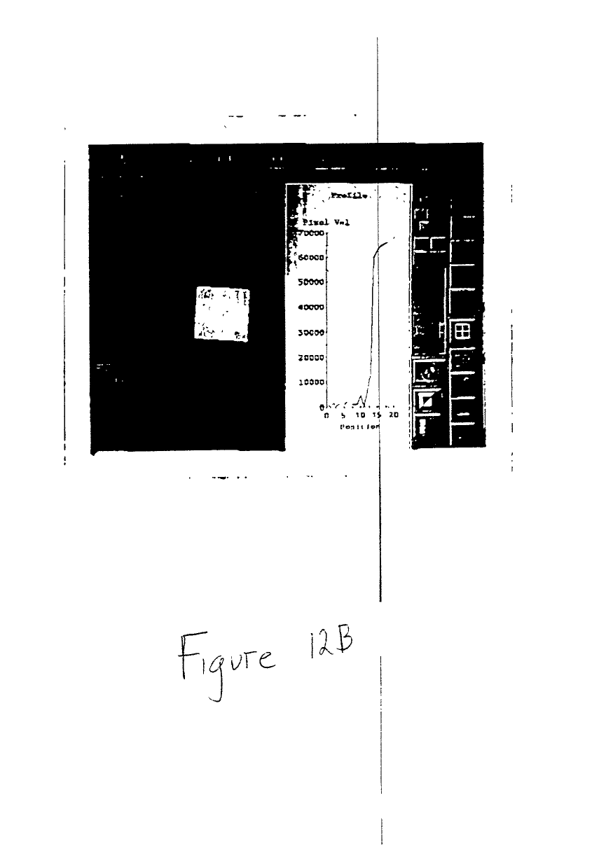

If data is acquired with an extra template slice used for field stability correction or there are other spoiler pulses placed at the end of the TR cycle, the phase distortion in the first two or three slices may not be the same as each other and may be different from the other slices. In this case, the first few slices are treated individually from the rest of the slices. FIG. 14 illustrates a data/template acquisition with template slice. In FIG. 14, M is the number of data slices, N is the number of readout lines and K is the number of field vibration template lines.

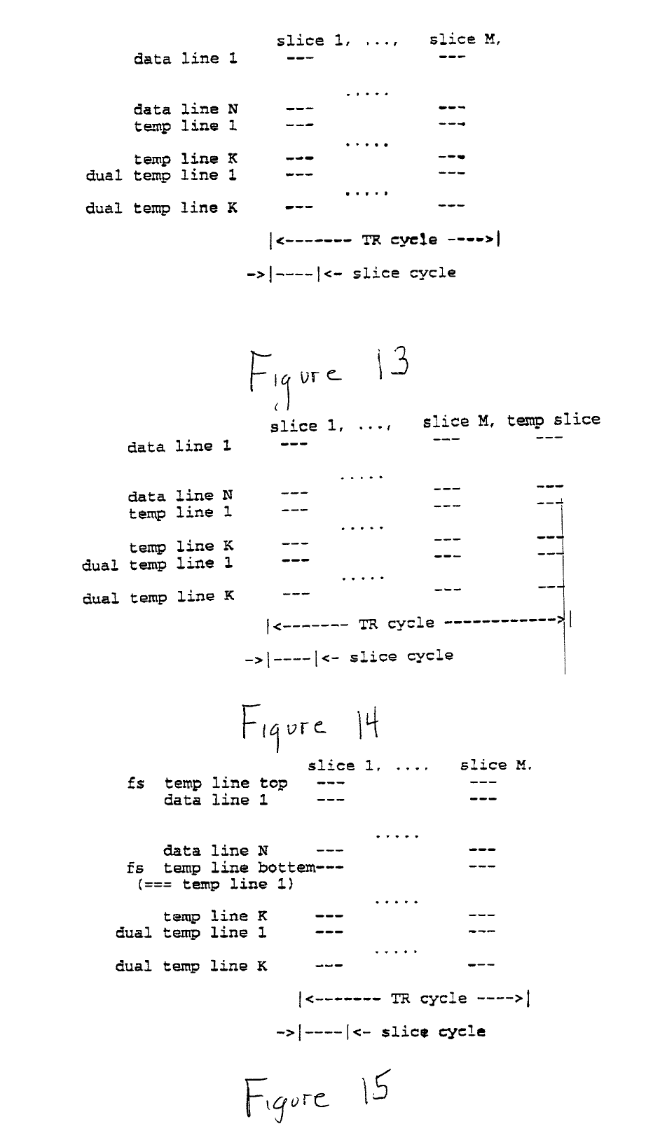

For those sequences with template lines for field stability correction, second template lines can be used for both field stability correction and for field vibration correction. FIG. 15 illustrates a data/template acquisition diagram with template lines for field stability correction. In FIG. 15, M is the number of data slices, N is the number of readout lines and K is the number of field vibration template lines.

The patent documents referenced above are incorporated herein in their entirety.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A magnetic resonance imaging method which gathers MRI data over a sequence of measurement cycles, comprising the steps of:
superimposing first magnetic gradient pulses on a nominally static magnetic field to selectively address NMR RF excitations for at least one predetermined volume;
superimposing second magnetic gradient pulses on said static magnetic field at other times in a measurement cycle;
performing at least one further of said measurement cycles during which at least one of said second gradient pulses is omitted so as to produce calibration data representative of the magnetic field then existing in the predetermined volume; and
using said calibration data to produce MRI data compensated for phase angle errors which otherwise would be present due to undesirable changes with respect to time in the magnetic field actually present in said predetermined volume,
wherein the MRI data is compensated for phase angle errors by applying to the measured image data the inverse of the phase angles determined during the at least one further of said measurement cycles.

2. The method according to claim 1, wherein a plurality of further measurement cycles are performed prior to generating the calibration data.

3. A magnetic resonance imaging apparatus which gathers MRI data over a sequence of measurement cycles, comprising:
means for superimposing first magnetic gradient pulses on a nominally static magnetic field to selectively address NMR RF excitations for at least one predetermined volume;
means for superimposing second magnetic gradient pulses on said static magnetic field at other times in a measurement cycle;
means for performing at least one further of said measurement cycles during which at least one of said second gradient pulses is omitted so as to produce calibration data representative of the magnetic field then existing in the predetermined volume; and
means for using said calibration data to produce MRI data compensated for phase angle errors which otherwise would be present due to undesirable changes with respect to time in the magnetic field actually present in said predetermined volume,
wherein the MRI data is compensated for phase angle errors by applying to the measured image data the inverse of the phase angles determined during the at least one further of said measurement cycles.

4. The apparatus according to claim 3, wherein a plurality of further measurement cycles are performed prior to generating the calibration data.

5. A magnetic resonance imaging method, comprising the steps of:
gathering MRI data from an imaged volume over a sequence of measurement cycles;
performing at least one pair of further calibration measurement cycles, wherein the polarity of all gradient pulses utilized in one cycle is reversed for another cycle and the respectively corresponding phases of measured NMR RF responses obtained in said pair of cycles is subtracted to provide calibration data substantially without chemical shift artifact and in the absence of applied magnetic gradients to produce calibration data; and
using said calibration data to produce MRI data compensated for errors which otherwise would be present due to undesirable changes with respect to time in the magnetic field actually present in said imaged volume.

6. The method according to claim 5, wherein a plurality of pairs of further calibration measurement cycles are performed in order to achieve a steady state condition and the respectively corresponding phases of measured NMR RF responses obtained in the last of the plurality of pairs are subtracted to provide the calibration data.

7. A magnetic resonance imaging apparatus, comprising:
means for gathering MRI data from an imaged volume over a sequence of measurement cycles;
means for performing at least one pair of further calibration measurement cycles, wherein the polarity of all gradient pulses utilized in one cycle is reversed for another cycle and the respectively corresponding phases of measured NMR RF responses obtained in said pair of cycles is subtracted to provide calibration data substantially without chemical shift artifact and in the absence of applied magnetic gradients to produce calibration data; and
means for using said calibration data to produce MRI data compensated for errors which otherwise would be present due to undesirable changes with respect to time in the magnetic field actually present in said imaged volume.

8. The apparatus according to claim 7, wherein a plurality of pairs of further calibration measurement cycles are performed in order to achieve a steady state condition and the respectively corresponding phases of measured NMR RF responses obtained in the last of the plurality of pairs are subtracted to provide the calibration data.

9. A magnetic resonance imaging method which gathers MRI data over a sequence of measurement cycles, comprising the steps of:
generating MRI data for a specified volume by superimposing magnetic gradient pulses on a nominally static magnetic field during a sequence of measurement cycles; and
using at least one of the shape and position of the magnetic gradient pulses to compensate for variations of the static magnetic field with respect to time caused by the gradient pulses.

10. A magnetic resonance imaging method which gathers MRI data over a sequence of measurement cycles, comprising the steps of:
generating MRI data for a predetermined volume by superimposing magnetic gradient pulses on a nominally static magnetic field during a sequence of measurement cycles; and
superimposing additional pulses on said static magnetic field during the measurement cycles to compensate for variations in the static magnetic field with respect to time caused by the magnetic gradient pulses.

11. A magnetic resonance imaging method which gathers MRI data over a sequence of measurement cycles, comprising the steps of:
generating MRI data for a predetermined volume by superimposing magnetic gradient pulses on a nominally static magnetic field during a plurality of measurement cycles;
measuring variations in the static magnetic field with respect to time generated by the magnetic gradient pulses; and
using the measured variations to produce MRI data compensated for errors which otherwise would be present in the magnetic field actually present in said predetermined volume due to the magnetic gradient pulses.

12. A magnetic resonance imaging apparatus which gathers MRI image data over a sequence of measurement cycles, comprising:
means for generating MRI data in a predetermined volume by superimposing magnetic gradient pulses on a nominally static magnetic field during a sequence of measurement cycles;
means for measuring variations in the static magnetic field with respect to time generated by the magnetic gradient pulses; and
means for using the measured variations to produce MRI data compensated for errors which otherwise would be present in the magnetic field actually present in said predetermined volume due to the magnetic gradient pulses.
